(19) United States
(12) Patent Application Publication
(10) Pub. No.: US 2009/0303828 A1
(43) Pub. Date: Dec. 10, 2009

(54) METHOD OF FILLING POTHOLES AND APPARATUS FOR PERFORMING SAME

(75) Inventors: William R. Van Zante, Pella, IA (US); Karl Wayne Roozeboom, Pella, IA (US)

Correspondence Address: ZARLEY LAW FIRM P.L.C., CAPITAL SQUARE, 400 LOCUST, SUITE 200, DES MOINES, IA, 50309-2350, US

(73) Assignee: RING-O-MATIC MFG. CO., INC., Pella, IA (US)

(21) Appl. No.: 12/132,818

(22) Filed: Jun. 4, 2008

(51) Int. Cl. B28C 7/04; B28C 7/06; B28C 7/12

(52) U.S. Cl. 366/8; 366/18

(57) ABSTRACT

A method and apparatus for filling a pothole has a cleaning system and a mixing system. The cleaning system loosens debris that is removed from the pot pothole prior to filling. The mixing system has an emulsion tank, an aggregate tank, a mixing tank, and an activator tank. The mixing tank is filled with emulsion and aggregate is added based on the weight of the emulsion to form a slurry. The slurry is transported to a static mixer where activator is added, and then the mixture is discharged into a pothole.

### BACKGROUND OF THE INVENTION

This invention is directed toward a method and apparatus for filling potholes and more particularly toward a method and apparatus for preparing a pothole and filler material.

Various methods of filling a pothole are known in the art. One method, generally known as “hot patch” involves heating asphalt material so that it will flow and then filling a hole. Another method, known as “cold patch” involves dumping material from a bag into a hole, and then tamping the material down. A still further method involves mixing aggregate with emulsion in a 5 gallon bucket and then filling a hole.

While helpful, these methods are time consuming and labor intensive. For example, on large highway projects, not only must containers of material be shipped to a site, but they must be manually opened and mixed prior to application. Therefore, there is a need in the art for an improved method and apparatus for filling potholes.

An objective of this invention is to provide a method and apparatus of filling a pothole that is less time consuming.

Another objective of the present invention is to provide a method and apparatus of filling a pothole that is more automatic.

A still further object of the present invention is to provide a method and apparatus for filling a pothole that is adjustable based on temperature, humidity, and application conditions.

These and other objectives will be apparent to those skilled in the art based on the following written description.

### SUMMARY OF THE INVENTION

A method and apparatus for filling a pothole has a cleaning system and a mixing system. The cleaning system includes a vacuum tube connected to a vacuum tank with a vacuum line and a spray nozzle connected to a water tank. The mixing system has an emulsion tank, an aggregate tank, a mixing tank, and an activator tank. The mixing tank is filled with emulsion and aggregate is added based on the weight of the emulsion to form a slurry. The slurry is transported to a static mixer where activator is added, and then the mixture is discharged into a pothole. Alternatively, aggregate is transported from the aggregate tank to a mixer while activator is added. Emulsion is transported to the mixer and added to the aggregate and activator to form a slurry that is discharged into a pothole.

### BRIEF DESCRIPTION OF THE DRAWINGS

FIG. 1 is a side view of a material mixing system;

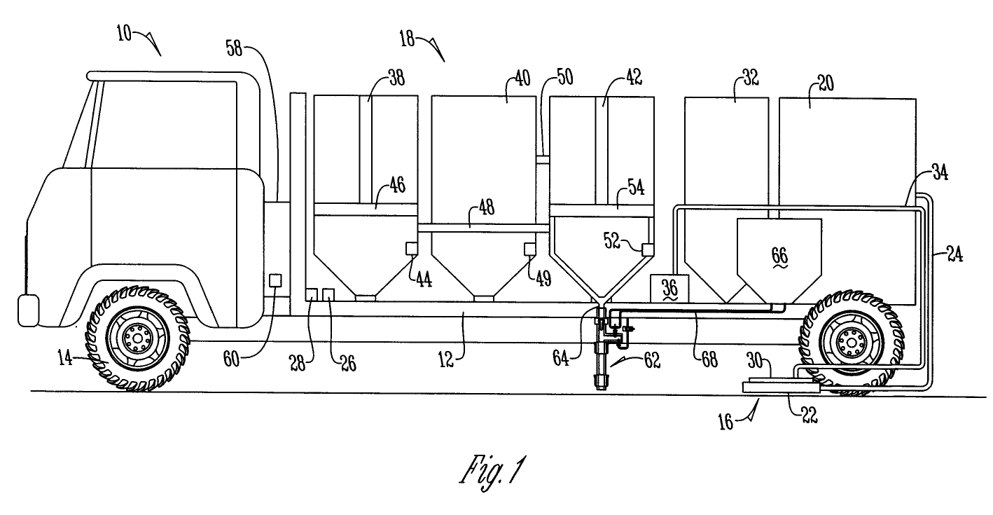

FIG. 2 is a schematic of a pothole cleaning and material mixing system;

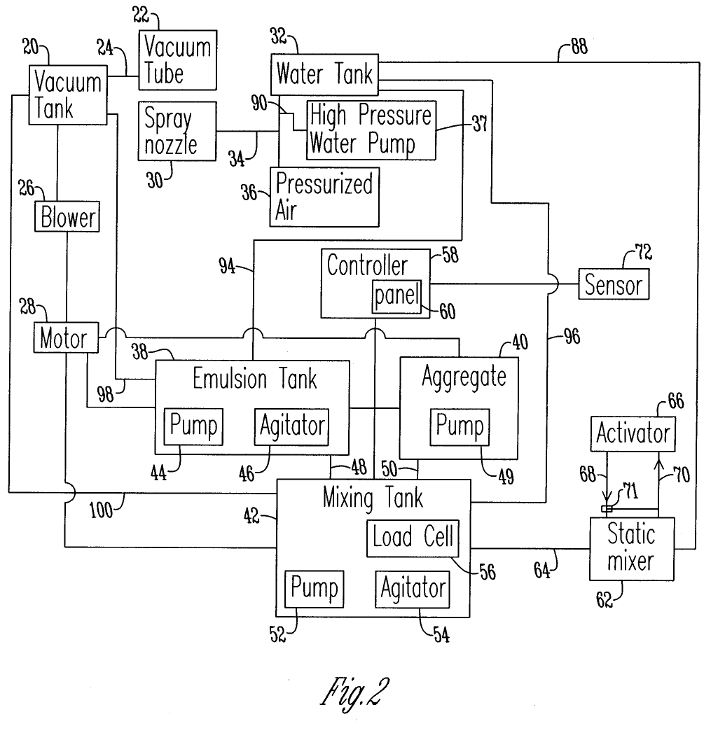

FIG. 3 is a plan view of a static mixer;

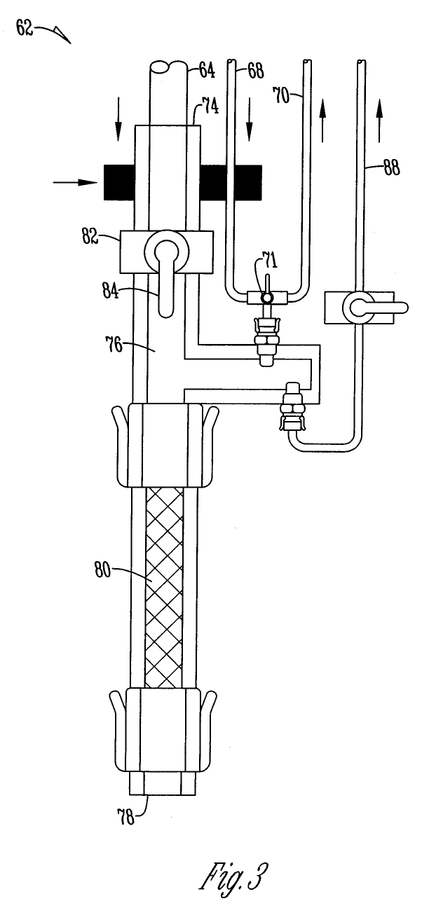

FIG. 4 is a flow diagram of a method for cleaning and filling a pothole;

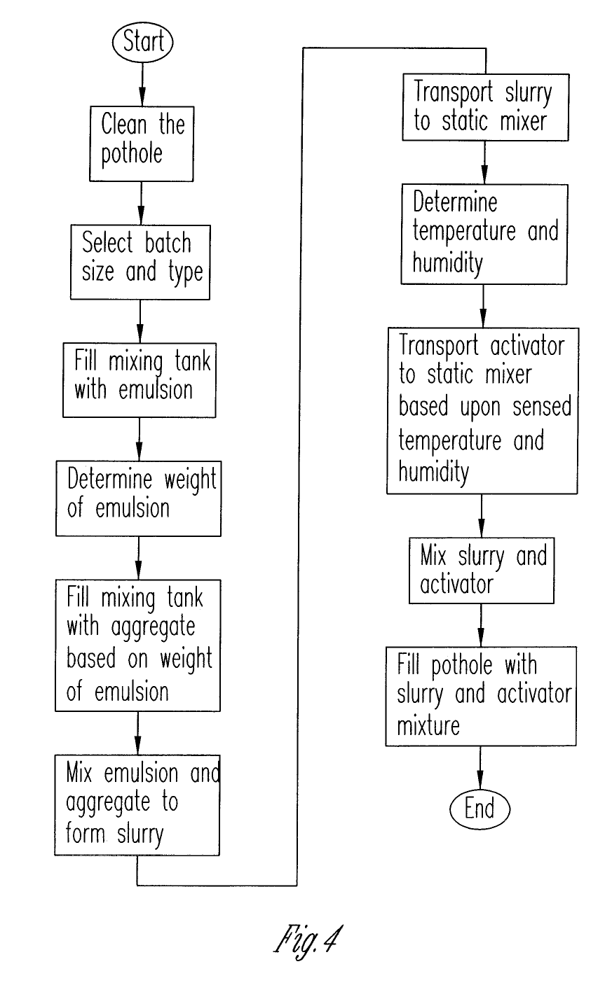

FIG. 5 is a side view of an apparatus for cleaning and filling a pothole;

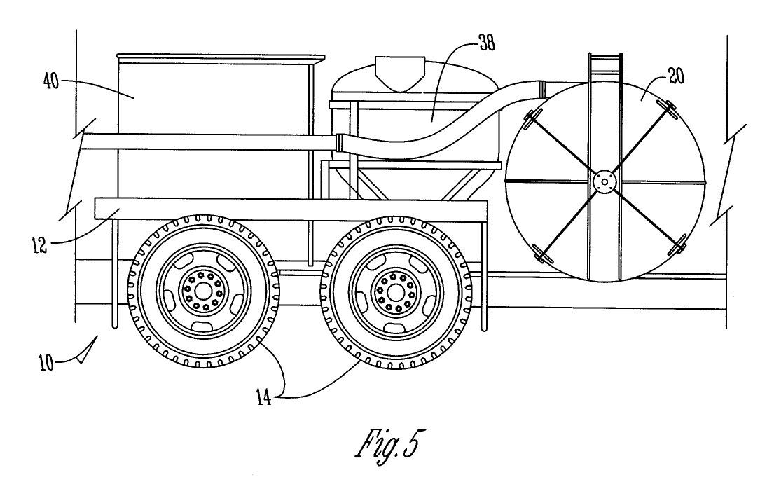

FIG. 6 is a perspective view of a boom for filling a pothole;

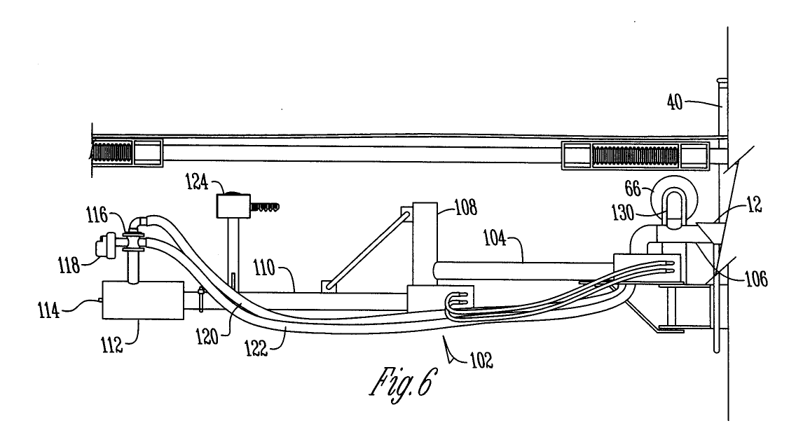

FIG. 7 is a perspective view of a mixer on the end of a boom;

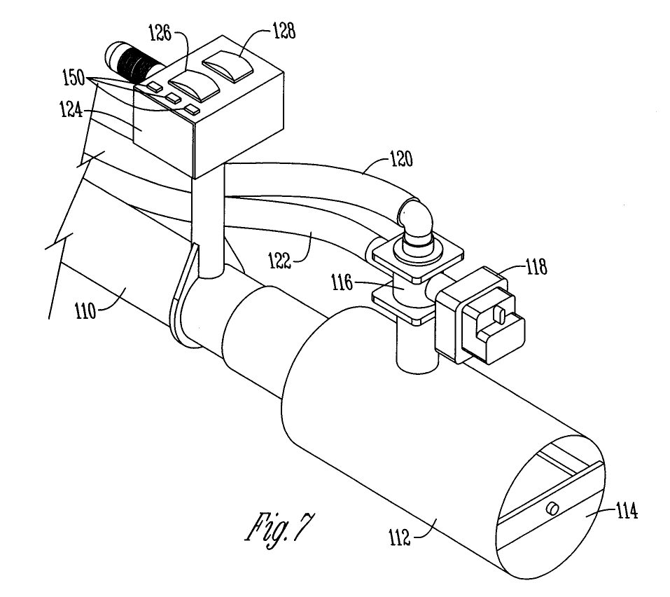

FIG. 8 is a perspective view of an activator tank;

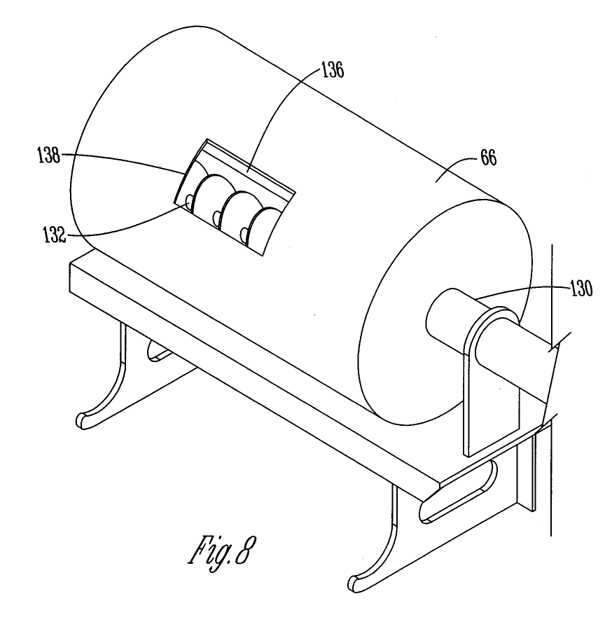

FIG. 9 is a schematic of a pothole cleaning and material mixing system;

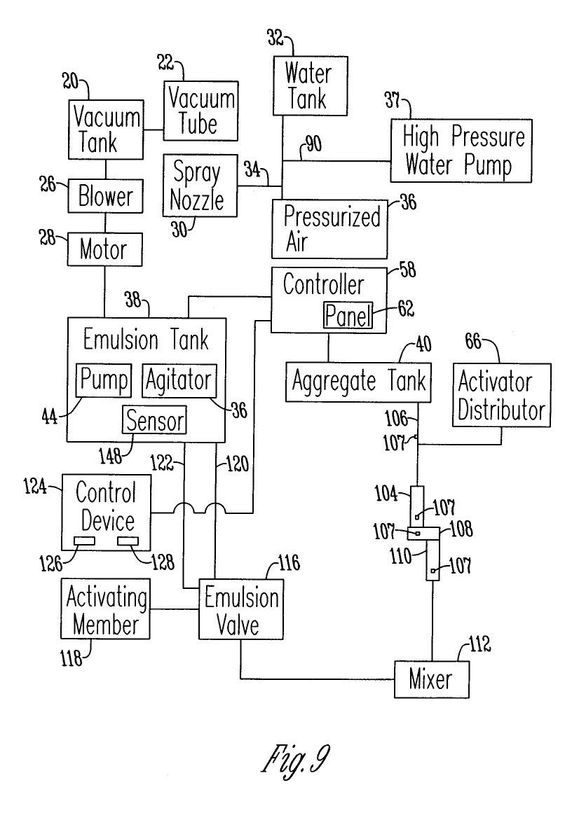

FIG. 10 is a flow diagram of a method for cleaning and filling a pothole; and

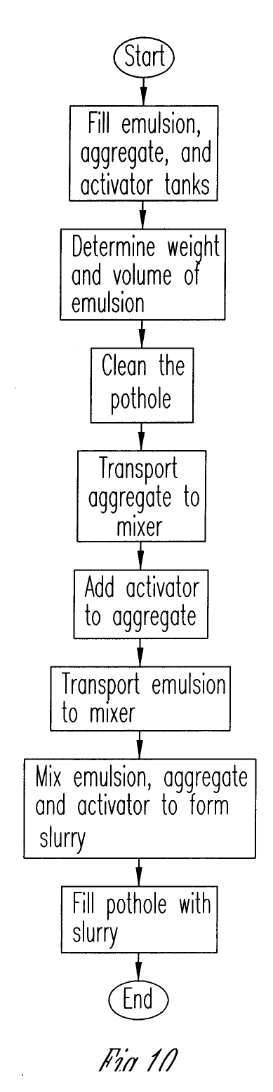

FIG. 11 is a perspective view of a cleaning assembly.

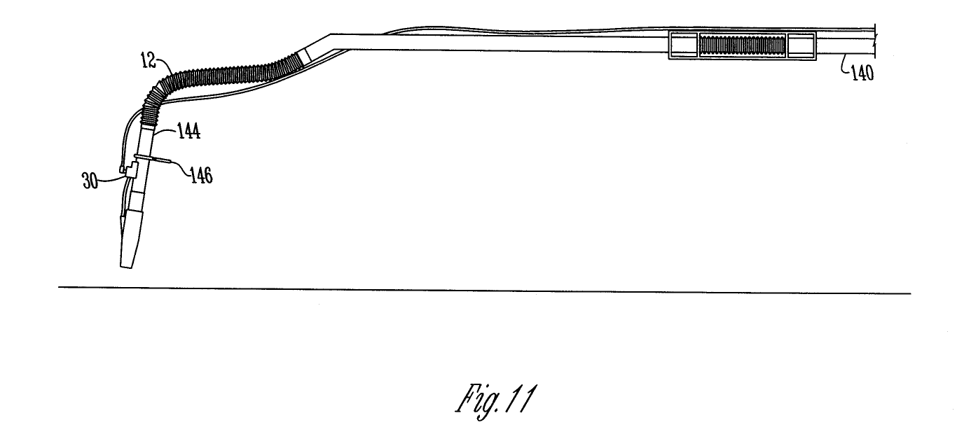

### DETAILED DESCRIPTION OF THE PREFERRED EMBODIMENTS

Referring to the Figures, a vehicle 10 (either a truck or a trailer) has a frame 12 with rotatable support wheels 14. Mounted to the frame 12 of the vehicle 10 is a hole cleaning assembly 16 and a material mixing assembly 18.

The hole cleaning assembly 16 includes a vacuum tank 20 connected to a vacuum tube 22 via a vacuum line 24. The vacuum tank 20 is connected to a blower 26 that is connected to and powered by a motor 28. Attached to the vacuum tube 22 is a spray nozzle 30. The spray nozzle is attached to the exterior of the tube 22 or may be disposed within. The spray nozzle 30 is connected to a water tank 32 via a first water line 34. Alternatively, the spray nozzle 30 is connected to air compressor 36. A high pressure water pump 37 is connected to the water tank 32 which in turn is connected to spray nozzle 30.

In operation, the hole cleaning assembly 16 cleans and prepares a pothole prior to filling with material. More specifically, high pressure water or air from the spray nozzle 30 loosens debris which is gathered by the vacuum tube 22 and deposited in the vacuum tank 20 through vacuum line 24. The vacuum force is created by the blower 26.

The material mixing assembly includes an emulsion tank 38, an aggregate tank 40, and a mixing tank 42. The three tanks 38, 40 and 42 are mounted to the frame, or alternatively the emulsion tank 38 and aggregate tank 40 are remote and separate from the vehicle 10, particularly for larger projects.

The emulsion tank 38 has a pump 44 and an agitator 46 that are operatively connected to the motor 28. Emulsion from tank 38 is selectively provided to the mixing tank 42 via fluid line 48. The aggregate tank 40 contains aggregate such as pumice for mixing with the emulsion to form a slurry and a pump 49. Aggregate from tank 40 is selectively provided to the mixing tank 42 via an auger on line 50.

The mixing tank 42 has a pump 52, an agitator 54, and a load cell 56. The emulsion tank 38, aggregate tank 40, and mixing tank 42 are all electrically connected to a controller 58. The controller 58 has a control panel 60 for inputting instructions to the material mixing assembly 18. The controller 58 in one embodiment is a PLC having a hand held wireless remote or tethered remote to operate the system. To mix material, an operator selects a pre-determined mixing ratio based on conditions by manually engaging the control panel 60. For example, for a regular batch, where material is mixed at a predetermined ratio of emulsion to pumice, an operator selects the regular batch button on the control panel 60. If the operator is applying material to a pothole on a hill they would select a thick batch button where more pumice is added to the mixing tank 42. For a thin batch, less pumice would be added to the mixing tank 42.

Once the batch size is selected, the controller 58 signals a predetermined amount of emulsion pumped from the emulsion tank 38 to the mixing tank 42 through line 48. Once pumped into the mixing tank 42, the emulsion is weighed by the load cell 56. The controller 58 then signals the aggregate tank 40 to pump an amount of pumice to the mixing tank 42 via line 50. Once the emulsion and pumice are pumped to the mixing tank 42, the agitator 54 is activated and rotates a determined number of revolutions to mix the slurry.

The mixing tank 42 is connected to a static mixer 62 via a slurry line 64. Also connected to the static mixer is an activator tank 66. The activator tank 66 has a first line 68 that transports activator to the static mixer 62 and a second, or recycling line 70 that transports activator from the static mixer 62 to the activator tank 66. A diverter valve 71 is mounted between lines 68 and 70 to direct flow to either the static mixer 62 or the activator tank 66.

The activator tank 66 is also connected to the controller 58 which is connected to a sensor 72 that measures temperature and humidity. The controller 58 regulates the flow of activator based on the sensed temperature and humidity.

The static mixer 62 has an input end 74 connected to slurry line 64 with a hollow conduit 76 that extends to a discharge end 78. Disposed within the hollow conduit 76 is a rotatable mixer 80 that mixes the slurry with the activator prior to application. Mounted on the static mixer 62 is a valve 82 that is operatively controlled by a handle 84 for allowing and preventing the flow of slurry.

In operation, once the slurry is mixed in the mixing tank 48, slurry is either pumped or delivered using an auger from tank 42 to the static mixer 62 through slurry line 64. Activator is also pumped from the activator tank 66 to the static mixer 62 via first activator line 68. Both the mixer valve 82 and the diverter valve are moved to an open position to allow slurry and activator to flow to the rotatable mixer 80 where they are mixed prior to reaching the discharge end 78.

When application is completed, diverter valve 71 and mixer valve 82 are closed and activator is recycled through second line 70 to the activator. The slurry may be discharged through the static mixer 62 or the slurry line 64 is disconnected from the static mixer and connected to an inlet port 86 on the mixing tank 42. In this way, the slurry is circulated from tank 42 through line 64 and back to tank 42 which is desirable when transporting the vehicle 10 to a new job site.

To clear the system after application the water tank 32 has a second water line 88 connected to the static mixer 62 to purge the mixer of slurry and activator. The water tank 32 also has a third water line 90 connected to a power washer wand 92. The power washer wand 92 is used to spray down the vehicle, as well as spray the interior of the emulsion tank 38 and the mixing tank 42. There is also water lines 94 and 96 that extend from the water tank 32 to the emulsion tank 38 and mixing tank 42 for flushing each, and lines 98 and 100 that extend from tanks 38 and 42 to the vacuum tank 20.

In an alternative embodiment mixing occurs at the end of a pivotable boom 102 that permits use by a single operator. The boom 102 has a first section 104 that is pivotably connected to the frame 12. The first section 104 is in communication with line 106 that extends from the aggregate tank 40 to the first section 104. Within the first section 104 and line 106 are augers to transport aggregate. Connected to the augers are speed sensors 107. The speed sensors 107 are connected to the controller 58. The controller adjusts the rotational speed of the augers based on the sensed speed to maintain a pre-selected rate of flow of the aggregate. At the opposite end of the first section 104 is a pivotable joint 108 that is connected to a second section 110 of the boom 102. The second section 110 through joint 108, is in communication with the first section 104. At the opposite end of the second section 110 is a mixer 112 having a discharge port 114. Disposed within second section 110 is an auger that transports aggregate from the joint 108 to the mixer 112. A sensor 107 is connected to the augers in joint 108 and section 110.

Connected to and in communication with the mixer 112 is an emulsion valve 116. The emulsion valve is operatively connected to an activating member 118 such as a solenoid and is connected to and in fluid communication with an emulsion in-flow line 120 and an emulsion outflow line 122. The inflow line 120 and outflow line 122 are connected to and in communication with the emulsion tank 38.

The activating member 118 is connected to, either electrically or wirelessly, to a control device 124. The control device 124 is connected to the controller 58 and preferably has at least two activation buttons 126 and 128. The first activation button 126 sends a signal to controller 58 that sends a signal to activating member 118 which controls the flow of emulsion either to the mixer 112 when the outflow line 122 is closed, or to the outflow line 122 when the port to the mixer 112 is closed. The other activation button 128 sends a signal to the controller 58 which in turn controls the flow rate of the emulsion in the inflow line 120.

An activator distributor 66 has a line 130 connected to and in communication with line 106 to add activator to the aggregate. Preferably, the activator distributor 66 has an auger 132. The distributor 66 has a plurality of fins 136 that extend internally. The distributor 66 has an opening 138 and a removable cover (not shown). The auger 132 is disposed within the distributor 66 and both the auger 132 and distributor 66 are connected to a drive (not shown) such that the auger 132 and the distributor 66 rotate together. Line 130 extends through distributor 66 and is cutaway to allow the activator to reach auger 132.

The cleaning assembly is mounted to a boom 140, that is pivotably mounted to the frame 12. Disposed within the boom is a vacuum tube 12 that is connected to the vacuum tank via vacuum line 24. Attached to the end of boom 140 is a vacuum gun 144 that has a handle 146. Mounted to the vacuum gun 144 is spray nozzle 30. The boom 140 creates an ergonomic cleaning assembly, that is safer to use, and easily operated.

Mounted within the emulsion tank 38 is a weight sensor 148. The sensor is connected to the controller. The sensor detects the weight of the emulsion within the tank 38 and sends a signal to the controller 58. Based on the signal and the known weight of emulsion, the controller 58 determines the volume of the emulsion and displays the volume on panel 62.

In operation, the emulsion tank 38, aggregate tank 40, and activator distributor 66 are filled. Initially, button 126 on control device 124 is engaged to activate agitator 36 in emulsion tank 38 which runs for a predetermined amount of time. LED's 150 on control device 124 will flash, and/or panel 62 will display that the emulsion is mixed. Once mixed the pothole is cleaned by switching on the water pump at the control device, throttle up the engine, and hook gun 144 to boom 140. Using the spray nozzle 30, air and/or water is used to loosen debris that is then vacuumed away. Once cleaned, boom 140 is pushed out of the way.

To fill the hole, button 126 is pressed which starts the aggregate augers and opens the emulsion valve 116 to allow emulsion to mix with aggregate and activator. Once mixed the slurry is discharged through port 114 into the hole. If the emulsion tank 38 is running low, an alarm, triggered by controller 58, will sound.

The controller 58 records the amount of emulsion at the beginning of a job and at the end, and can determine the amount of material used over a period of time as well as the cost. This information is either displayed or printed.

Therefore a method and apparatus for filling a pothole has been described that, at the very least, meets all the stated objectives.

What is claimed is:

1. A method of filling a pothole, the method comprising the steps of:
filling a mixing tank with emulsion;
determining the weight of the emulsion in the mixing tank;
adding aggregate to the mixing tank based on the determined weight of the emulsion,
mixing the emulsion and the aggregate to create a slurry; and
filling the pothole with the slurry.

2. The method of claim 1 further comprising the step of transporting the slurry to a static mixer.

3. The method of claim 2 further comprising the step of mixing activator with the slurry at the static mixer.

4. The method of claim 1 further comprising the step of cleaning the pothole prior to filling the pothole with the slurry.

5. The method of claim 4 wherein high pressure fluid loosens debris that is gathered by a vacuum tube to clear the pot hole prior to filling.

6. The method of claim 4 wherein high pressure air loosens debris that is gathered by a vacuum tube to clear the pot hole prior to filling.

7. An apparatus for filling a pothole, comprising:
a vehicle having a frame;
an emulsion tank, aggregate tank, and mixing tank mounted to the frame;
the emulsion tank adapted to pump emulsion to the mixing tank based upon a determined batch size;
the aggregate tank adapted to pump aggregate to the mixing tank based upon the weight of the emulsion pumped into the mixing tank; and
the mixing tank having an agitator to mix the emulsion and aggregate to create a slurry.

8. The apparatus of claim 6 further comprising a static mixer connected to the mixing tank.

9. The apparatus of claim 7 further comprising an activator tank mounted to the frame and connected to the static mixer.

10. The apparatus of claim 6 further comprising a vacuum tank mounted to the frame and connected to a vacuum tube.

11. The apparatus of claim 6 further comprising a water tank mounted to the frame.

12. The apparatus of claim 6 further comprising an air compressor mounted to the frame.

13. An apparatus for filling a pothole, comprising:
a frame;
an emulsion tank, aggregate tank, and activator tank mounted to the frame;
a line extending from the aggregate tank to a mixer; and
a line extending from the emulsion tank to the mixer.

14. The apparatus of claim 12 further comprising a valve connected to the mixer and the emulsion.

15. The apparatus of claim 13 wherein the valve is operably connected to an activating member.

16. The apparatus of claim 13 wherein a boom is pivotably mounted to the frame and the mixer is attached to the boom.

17. The apparatus of claim 13 wherein the activator tank is connected to the line extending from the aggregate tank to the mixer.

18. The apparatus of claim 16 wherein the boom has a first section and a second section connected at a pivotable joint.
